(19) United States
(12) Patent Application Publication
(10) Pub. No.: US 2019/0322007 A1
(43) Pub. Date: Oct. 24, 2019

(54) LAMPSHADE AND METHOD FOR MANUFACTURING LAMPSHADE

(71) Applicant: Xiamen Britesun Technology Co., Ltd., Xiamen (CN)

(72) Inventors: Yan JIANG, Xiamen (CN); Puming JIANG, Xiamen (CN); Yanhui ZHANG, Xiamen (CN); Ziyang HE, Xiamen (CN)

(73) Assignee: Xiamen Britesun Technology Co., Ltd., Xiamen (CN)

(21) Appl. No.: 16/387,025

(22) Filed: Apr. 17, 2019

(30) Foreign Application Priority Data
Apr. 18, 2018 (CN) 201810346312.6

(51) Int. Cl. B29B 7/90; B29C 45/00

(52) U.S. Cl. CPC B29B 7/90; B29K 2069/00; B29C 45/0001

(57) ABSTRACT

The present application relates to a method for manufacturing a lampshade, which manufactures a lampshade by adding a lubricant, a dispersant and phosphors to a PC material, and then performing high temperature thermal injection molding for one time. This application further relates to a lampshade. The lampshade can be put into mass practical production, and a lamp produced using this lampshade has superior luminous efficiency, reliability and stability over a conventional non-remote technique lamp in a high temperature environment.

### CROSS-REFERENCE OF RELATED APPLICATION

The present US application claims the benefit of Chinese Patent Application No. CN201810346312.6, filed on Apr. 18, 2018, the entire disclosure of which is incorporated herein by reference.

### TECHNICAL FIELD

The present disclosure relates to the field of LED lighting, and particularly to a lampshade and a method for manufacturing lampshade for use in a remotely excited LED lamp.

### BACKGROUND

Remote excitation is a way of molding an LED lamp. A blue light chip is fixed on an SMD specific support or a COB heat sink substrate, and then coated with transparent colloid and solidified to form an LED light source device. The LED light source device is covered with a phosphor-added component (such as a lampshade, hereinafter referred to as a remote phosphor lampshade), and installed with a driving circuit, etc. to make an LED lamp. Blue light (wavelength 450-460 nm) emitted by the blue chip is directly irradiated onto the remote phosphor lampshade, emitting white light. Due to a certain distance between the remote phosphor lampshade and the blue light chip, it is called a remote phosphor excitation mode.

The remote phosphor lampshade can be molded by various methods. The first one is: phosphors and transparent silica gel are mixed at a certain ratio, and molded by a mold and solidified to form a lampshade (with spherical shape, cylindrical shape, plate shape, etc.). The second one is phosphors and a certain transparent colloid are mixed at a certain ratio and then coated on a transparent material such as transparent glass or transparent plastic. The third one is: phosphors and transparent plastic (such as PC, PMMA, etc.) are mixed at a certain ratio and form lampshades of various shapes (such as bulb shape, flying saucer shape, olive shape, etc.) by thermal injection molding. For the first and second methods, it is difficult to control the process thereof, resulting poor uniformity of the lampshade. This makes it difficult for the lampshade to be put into mass industrial production.

Although the third method is realized by a mature thermal injection molding process, due to the addition of materials such as phosphors, it produces new process problems (described below), and is currently not put into mass practical production. 1. Currently, the phosphor materials added to the remote phosphor lampshade are mainly inorganic compounds such as silicates, aluminates, phosphates, nitrides, and the like. These inorganic compounds have high hardness (exceeding the hardness of ordinary steel), large specific gravity, and fine particles. During the thermal injection molding process, non-lubricating, hard, and dry friction occurs between these materials at high temperature and the metal material surfaces of the injection screw, the barrel and the nozzle of the molding machine which are rotated at high speed, producing a large amount of metal powders and fine metal oxide powders. These will contaminate even blacken the lampshade. These metal powders and fine metal oxide powders are evenly dispersed in the lampshade, blocking and absorbing visible light emitted by the phosphors, and resulting in a decrease of more than 50% in luminous efficiency, and no practicality. 2. Since the phosphor has a large specific gravity (3-7 g/cm³), and it is prone to settle during the process of being mixed with a PC material, it can hardly form a uniform mixture with the PC material, which causes uneven light emission of the lampshade formed by thermal injection molding.

Patent No.: CN201310208539, titled “a remotely excited fluorescent polycarbonate composite material and a preparation method thereof”, introduces a method for manufacturing a lampshade by mixing phosphors with materials such as polycarbonate (transparent PC plastic), and then performing re-granulation and thermal injection molding process. This technology needs to perform high temperature granulation and then high temperature thermal injection molding. During the two high temperature manufacturing processes, the phosphors rub against the metal materials twice, increasing the contamination degree of the mixture. Moreover, most plastics such as PC are not suitable for repeated high temperature processing, which are prone to thermal decomposition, resulting in material degradation and performance deterioration.

### SUMMARY

The present application provides a lampshade and a method for manufacturing a lampshade, which seeks to solve the process problem resulting from the addition of materials such as phosphors in the process of manufacturing a remote phosphor lampshade by means of process design etc., so that the process of mixing polycarbonate (PC) with phosphors and then performing thermal injection molding can be put into mass practical production.

In an attempt to solve the above-mentioned technical problem, the present application adopts the following technical solutions.

In one aspect, the present application provides a manufacturing method for a lampshade, comprising steps of: step 1: adding high-temperature resistant silicone oil to PC material, and stirring the high-temperature resistant silicone oil and the PC material at a low speed for 30 to 60 minutes, so as to obtain a first mixture; step 2: adding dispersed oil to the first mixture, and stirring the dispersed oil and the first mixture at a low speed for 30 to 60 minutes, so that the dispersed oil and the first mixture are uniformly mixed to obtain a second mixture; step 3: preparing phosphors according to a required color temperature range 2700K-6500K of an LED lamp, adding the phosphors to the second mixture, and stirring the phosphors and the second mixture at a low speed for 30 to 60 minutes, so as to obtain a third mixture; step 4: pouring the third mixture into an injection molding machine, which is injection molded at one time at a temperature of 270-330° C., therein the weight ratio between the high-temperature resistant silicone oil and the PC material is 0.1-0.5%, the weight ratio between the dispersed oil and the PC material is 0.01-0.05%, and the weight ratio between the phosphors and the PC material is 10-3%.

In optional embodiments, an injection screw, a barrel and a nozzle of the injection molding machine are respectively made of an alloy material having a surface hardness higher than that of the phosphor, the alloy material having a surface hardness higher than that of the phosphor being any one of SKD61 alloy, HPT3 alloy, and HK6 alloy.

In optional embodiments, the silicone oil in step 1 has a high temperature resistance of 300° C. or higher.

In optional embodiments, the stirring speed in step 1, step 2 and step 3 is less than 1000 rpm.

In another aspect, the present application provides a lampshade which is injection molded by a mixture, and the mixture comprises PC material as base material, high-temperature resistant silicone oil with a weight ratio of 0.1-0.5%, dispersed oil with a weight ratio of 0.01-0.05%, and phosphors with a weight ratio of 10-3%.

The lampshade according to the present application only undergoes high temperature molding process at one time during the manufacturing process, during which the silicone oil is used as a lubricant, so that the manufacturing material thereof is not prone to cause abrasion to the alloy material having a higher surface hardness than that of the phosphor, and the dispersed oil makes the mixing more uniform. The lampshade according to the present application can be put into mass practical production, and a lamp produced using this lampshade has a superior luminous efficiency, reliability and stability over a conventional non-remote technique lamp, in a high temperature environment.

### BRIEF DESCRIPTION OF THE DRAWINGS

The drawings are included to provide a further understanding of embodiments, and the drawings are incorporated in this specification and constitute a part of this specification. The drawings illustrate the embodiments and, together with the description, explain the principles of the present invention. Other embodiments and many intended advantages of the embodiments will be readily appreciated, as they will become better understood by reference to the detailed description below. The elements in the drawings are not necessarily drawn to scale. The same reference numerals refer to corresponding similar components.

FIG. 1 illustrates a flow chart of a method for manufacturing a lampshade according to an embodiment of the present application.

### DETAILED DESCRIPTION

The present application will be further described in detail below with reference to embodiments, however detailed implementations of the present application are not so limited.

The inventors found in practice that: when an injection molding machine is used to make a remote phosphor lampshade, the added phosphors rub against the components such as the injection screw, the barrel, the nozzle, and the like in the molding machine, so that these metal materials are abraded, thereby making the manufactured lampshade contaminated. The main reasons are as follows:

1. The surface hardness of the metal materials of the components such as the injection screw, barrel, nozzle and the like in the molding machine is lower than that of the phosphor;

2. The phosphors rub against the surfaces of the components such as the injection screw, the barrel, the nozzle, and the like in a non-lubricating, hard, and dry manner.

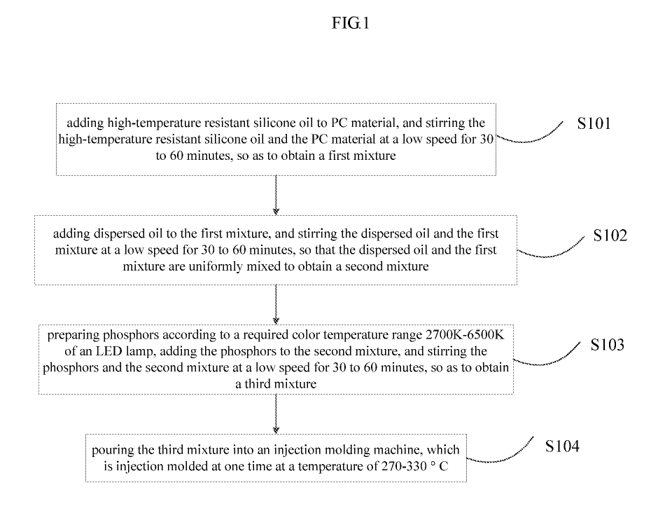

In order to prevent the corrosion of the metal material from affecting the performance of the lampshade, the inventors replaced the components such as the injection screw, the barrel, the nozzle, and the like of a conventional injection molding machine on the market with those made of an alloy material (which include, but are not limited to, for example, an SKD61 alloy, an HPT3 alloy and an HK6 alloy) having a surface hardness higher than that of the phosphor, which are assembled into a new injection molding machine. In an embodiment, the method for manufacturing a lampshade comprises the following steps (as shown in FIG. 1).

Step 101: adding high-temperature resistant (such as 300° C.) silicone oil with a certain proportion (0.1-0.5% by weight) to a PC material, and stirring them in a mixing tank at a low speed (less than 1000 rpm) for 30 to 60 minutes, so that they are uniformly mixed to obtain a first mixture. This can solve the problem regarding non-lubricating, hard, and dry friction between the phosphors and the surfaces of the components such as the injection screw, the barrel, the nozzle and the like.

Step 102: adding dispersed oil with a certain proportion (0.01-0.05% by weight) to the mixture in step 101 described above, and stirring them in the mixing tank at a low speed (less than 1000 rpm) for 30 to 60 minutes, so that they are uniformly mixed to obtain a second mixture. The purpose of this step is to solve the problem regarding settlement of the phosphor during the process of being mixed with the PC material, so as to form a uniform mixture of the PC material and the phosphors.

Step 103: according to a required color temperature range 2700K-6500K of an LED lamp, preparing phosphors with a weight ratio of 10-3%, adding the phosphors to the second mixture in step 102, and stirring them in the mixing tank at a low speed (less than 1000 rpm) for 30 to 60 minutes, so that they are uniformly mixed to obtain a third mixture. Since the lubricant in step 101 and the dispersed oil in step 102 are added, the surfaces of the phosphor particles are coated with an oil film layer formed of two mixed oils, which firstly solves the problem regarding abrasion of the metal material surfaces, and secondly enables the phosphors to be effectively and uniformly adhered to the surface of the PC material, thereby solving the problem of uneven mixing.

Step 104: pouring the third mixture into a feeding tank of the injection molding machine, which is thermal injection molded by a mold at one time at an injection temperature of 270-330° C. according to a required shape (which includes, but is not limited to shapes such as a lampshade shape, a plate shape, and the like), thereby obtaining an LED remote phosphor lampshade that can be put into mass practical production. According to our experiments, a lamp produced using this lampshade can have superior luminous efficiency, reliability and stability over a conventional non-remote technique lamp in a high temperature environment.

Specifically, the weight ratio between the high-temperature resistant silicone oil and the PC material is 0.1-0.5%, the weight ratio between the dispersed oil and the PC material is 0.01-0.05%, and the weight ratio between the phosphors and the PC material is 10-3%.

Through repeated experiments, the inventors obtained experimental data and effects as shown in Table 1.

With respect to various proportioning test data of an LED lamp with a color temperature of 6500K, the proportions of the phosphors at respective color temperatures are generally fixed:

TABLE 1

| | additive | | | | |
|---|---|---|---|---|---|
| | | | | | luminous |
| | | | | | efficiency |
| | | | | | (under |
| | proportion | proportion | proportion | | the same |
| | of silicone | of dispersed | of | injection | amount |
| | oil | oil | phosphors | temperature | of blue |
| times | (%) | (%) | (%) | ° C. | light) lm/w |
| 1 | 0.1 | 0.01 | 8 | 300 | 115.5 |
| 2 | 0.25 | 0.025 | 8 | 300 | 117.5 |
| 3 | 0.5 | 0.05 | 8 | 300 | 114.8 |
| 4 | 0.05 | 0.07 | 8 | 300 | 60.5 |
| 5 | 0.65 | 0.08 | 8 | 300 | 65.2 |
| 6 | 0.06 | 0.09 | 8 | 300 | 62.5 |
| 7 | 0.7 | 0.007 | 8 | 300 | 66.2 |
| 8 | 0 | 0 | 8 | 300 | 45.3 |

It can be seen from the above experimental data that, at the same injection temperature, for methods for manufacturing a remote phosphor lampshade in which the same proportion of phosphors is added, a mixture of the PC material and the phosphors is added with silicone oil and dispersed oil, thus the luminous efficiency of the lampshade is higher than that of the lampshade made of a mixture not added with silicone oil and dispersed oil under the same amount of blue light. Moreover, the lampshade made of a mixture added with 0.1-0.5% by weight of silicone oil and 0.01-0.05% by weight of dispersed oil has a luminous efficiency 2.5 times the luminous efficiency of a lampshade made of a mixture not added with silicone oil and dispersed oil under the same amount of blue light.

The lampshade produced by the manufacturing method proposed by the present application only undergoes one time of high temperature molding process during which the silicone oil is used as a lubricant so that the manufacturing material thereof is not prone to cause abrasion to the alloy material having a higher surface hardness than that of the phosphor, and the dispersed oil makes the mixing more uniform.

What are stated above are only preferred embodiments of the present application, and are not intended to limit the technical scope of the present application. Therefore, any slight amendments, equivalent variations, and modifications made to the above-described embodiments in accordance with the technical essence of the present application still fall within the protection scope of the present application. The word “comprise” does not exclude the presence of the elements or steps that are not listed in the claims. The word “a” or “an” preceding an element does not exclude the presence of a plurality of such elements. The mere fact that certain measures are recited in mutually different dependent claims does not indicate that a combination of these measures cannot be used to advantage. Any reference numerals in the claims should not be construed as limiting.

1. A manufacturing method for a lampshade, comprising steps of:
step 1: adding high-temperature resistant silicone oil to PC material, and stirring the high-temperature resistant silicone oil and the PC material at a low speed for 30 to 60 minutes, so as to obtain a first mixture;
step 2: adding dispersed oil to the first mixture, and stirring the dispersed oil and the first mixture at a low speed for 30 to 60 minutes, so that the dispersed oil and the first mixture are uniformly mixed to obtain a second mixture;
step 3: preparing phosphors according to a required color temperature range 2700K-6500K of an LED lamp, adding the phosphors to the second mixture, and stirring the phosphors and the second mixture at a low speed for 30 to 60 minutes, so as to obtain a third mixture; and
step 4: pouring the third mixture into an injection molding machine, which is injection molded at one time at a temperature of 270-330° C.,
wherein the weight ratio between the high-temperature resistant silicone oil and the PC material is 0.1-0.5%, the weight ratio between the dispersed oil and the PC material is 0.01-0.05%, and the weight ratio between the phosphors and the PC material is 10-3%.

2. The manufacturing method for a lampshade according to claim 1, wherein an injection screw, a barrel and a nozzle of the injection molding machine are respectively made of an alloy material having a surface hardness higher than that of the phosphor, the alloy material having a surface hardness higher than that of the phosphor being any one of SKD61 alloy, HPT3 alloy, and HK6 alloy.

3. The manufacturing method for a lampshade according to claim 1, wherein the silicone oil in step 1 has a high temperature resistance of 300° C. or higher.

4. The manufacturing method for a lampshade according to claim 1, wherein the speed of the stirring in step 1, step 2 and step 3 is less than 1000 rpm.

5. A lampshade manufactured by the manufacturing method according to claim 1.
